(19) United States
(12) Patent Application Publication
(10) Pub. No.: US 2026/0052085 A1
(43) Pub. Date: Feb. 19, 2026

(54) USE OF PROPAGATION DELAY FROM TOPOLOGY DISCOVERY TO UPDATE A CLOCK

(71) Applicant: Microchip Technology Incorporated, Chandler, AZ (US)

(72) Inventor: Mary Sue Haydt, Ettlingen (DE)

(73) Assignee: Microchip Technology Incorporated, Chandler, AZ (US)

(21) Appl. No.: 19/064,059

(22) Filed: Feb. 26, 2025

Related U.S. Application Data
(60) Provisional application No. 63/683,322, filed on Aug. 15, 2024.

(51) Int. Cl. H04L 43/0864; H04L 41/12

(52) U.S. Cl. CPC H04L 43/0864; H04L 41/12

(57) ABSTRACT

A system and method for the use of propagation delay from topology discovery to update a clock in a 10BASE-T1S mixing segment are disclosed. The method may include determining a propagation delay. The propagation delay may be an amount of time for a signal to be received by a node after the signal is sent by a reference node. The method may also include receiving, at the node, a first message from the reference node after determining the propagation delay. The method may additionally include receiving, at the node, a second message from the reference node, the second message indicating a time the first message was sent. The method may include recording, at the node, a first timestamp indicating a time at which the first message is received. The method may further include updating a clock of the node using the first timestamp, the second message, and the propagation delay.

### PRIORITY

This application claims priority to U.S. Provisional Patent Application No. 63/683,322 filed Aug. 15, 2024, the contents of which are hereby incorporated in their entirety.

### TECHNICAL FIELD

The present disclosure relates to 10BASE-T1S networks, and, in particular, to the use of propagation delay from topology discovery to update a clock in a 10BASE-T1S mixing segment.

### BACKGROUND

10BASE-T1S is a physical layer standard designed for in-vehicle networks, offering low power consumption and cost-effectiveness. While it's primarily focused on data transmission, time synchronization is becoming increasingly important for various applications, such as automotive systems, where precise timing is used for coordinating different components. Unlike traditional Ethernet networks, 10BASE-T1S often employs a multidrop topology, where multiple devices share a single bus. This can introduce challenges in time synchronization due to varying transmission delays.

To reliably synchronize a clock follower to the local master, a reliable estimate of the transmission delay between the master and the follower is determined. Point-to-point networks may use PDelay_response and PDelay_followup messages of the precision time protocol (PTP) protocol, but these broadcast messages may be unsuitable on a multidrop bus. Current multidrop software designs use a value that is fixed for each node, and is based on a propagation delay estimate based on the distance of the cable to the node. This value does not allow for a network to change over time, including addition of optional nodes. Current methods for determining propagation delay in multidrop networks involve either theoretical calculations or measurements based on a fixed network topology.

### SUMMARY OF THE INVENTION

Aspects provide systems and methods for the use of propagation delay from topology discovery to update a clock in a 10BASE-T1S mixing segment. Examples of the present disclosure may include a method. The method may include determining a propagation delay. The propagation delay may be an amount of time for a signal to be received by a node after the signal is sent by a reference node. The method may also include receiving, at the node, a first message from the reference node after determining the propagation delay. The method may additionally include receiving, at the node, a second message from the reference node, the second message indicating a time the first message was sent. The method may include recording, at the node, a first timestamp indicating a time at which the first message is received. The method may further include updating a clock of the node using the first timestamp, the second message, and the propagation delay.

In combination with any of the above examples, determining the propagation delay may include receiving, at the node, a plurality of pulses from the reference node for a set time period, counting a number of pulses received, and determining the propagation delay based on the number of pulses received and the set time period.

In combination with any of the above examples, the method may include receiving, at the node, a signal from the reference node to initiate a topology discovery operation. The reference node may be part of a mixing segment including the reference node and a follower node. The method may also include receiving the signal from the reference node occurs after a new follower node is added to the mixing segment. The method may further include determining the propagation delay is performed during the topology discovery operation.

In combination with any of the above examples, the method may include receiving, at the node, a third message from the reference node. The method may also include receiving, at the node, a fourth message from the reference node, the fourth message indicating a time the third message was sent. The method may additionally include recording, at the node, a second timestamp indicating a time at which the third message is received. The method may further include updating the clock using the second timestamp, the fourth message, and the propagation delay.

In combination with any of the above examples, the method may include saving the propagation delay.

Alone or in combination with any of the above examples, examples of the present disclosure may include an apparatus with a receiver. The apparatus may also include a control circuit. The control circuit may be to determine a propagation delay. The propagation delay may be an amount of time for a signal to be received by the receiver after the signal is sent by a reference node. The control circuit may also be to receive, using the receiver, a first message from the reference node after determining the propagation delay. The control circuit may additionally be to receive, using the receiver, a second message from the reference node, the second message indicating a time the first message was sent. The control circuit may be to record a first timestamp indicating a time at which the first message is received. The control circuit may further be to update a clock using the first timestamp, the second message, and the propagation delay.

In combination with any of the above examples, the control circuit be to, in order to determine the propagation delay, receive, using the receiver, a plurality of pulses from the reference node for a set time period. The control circuit may be to count a number of pulses received. The control circuit may also be to determine the propagation delay based on the number of pulses received and the set time period.

In combination with any of the above examples, the control circuit be to receive, using the receiver, a signal from the reference node to initiate a topology discovery operation. The control circuit may also be to determine the propagation delay during the topology discovery operation. The reference node may be part of a mixing segment including the reference node and a follower node. Receiving the signal from the reference node may occur after a new follower node is added to the mixing segment.

In combination with any of the above examples, the control circuit be to receive, using the receiver, a third message from the reference node. The control circuit may also be to receive, using the receiver, a fourth message from the reference node, the fourth message indicating a time the third message was sent. The control circuit may be to record a second timestamp indicating a time at which the third message is received. The control circuit may further be to update the clock using the second timestamp, the fourth message, and the propagation delay.

In combination with any of the above examples, the apparatus may include a non-volatile memory. The control circuit may be to save the propagation delay to the non-volatile memory.

Alone or in combination with any of the above examples, examples of the present disclosure may include a method. The method may include transmitting a plurality of pulses for a set time period to a follower node to enable the follower node to determine a propagation delay. The propagation delay is an amount of time for a signal to be received by the follower node after the signal is sent by a reference node. The method may also include sending a first message to the follower node after transmitting the plurality of pulses. The method may further include sending a second message to the follower node, the second message indicating a time the first message was sent.

In combination with any of the above examples, the method may include instructing a follower node to perform a topology discovery operation prior to transmitting the plurality of pulses.

In combination with any of the above examples, the first and second messages may be precision time protocol messages.

In combination with any of the above examples, the method may include receiving a clock signal from a clock source.

In combination with any of the above examples, the first and second messages may be periodically transmitted during operation.

Alone or in combination with any of the above examples, examples of the present disclosure may include an apparatus having a transmitter. The apparatus may also include a control circuit. The control circuit may be to instruct the transmitter to transmit a plurality of pulses for a set time period to a follower node to enable the follower node to determine a propagation delay. The propagation delay may be an amount of time for a signal to be received by the follower node after the signal is sent by a reference node. The control circuit may also be to send a first message to the follower node after transmitting the plurality of pulses. The control circuit may further be to send a second message to the follower node, the second message indicating a time the first message was sent.

In combination with any of the above examples, the control circuit may be to instruct a follower node to perform a topology discovery operation prior to transmitting the plurality of pulses.

In combination with any of the above examples, the first and second messages may be precision time protocol messages.

In combination with any of the above examples, the control circuit may be to receive a clock signal from a clock source.

In combination with any of the above examples, the control circuit may be to periodically send the first and second messages during operation.

### BRIEF DESCRIPTION OF THE DRAWINGS

The figures illustrate examples of systems and methods for the use of propagation delay from topology discovery to update a clock in a 10BASE-T1S mixing segment.

FIG. 1 illustrates a block diagram of a 10BASE-T1S mixing segment, according to examples of the present disclosure;

FIG. 2 illustrates a block diagram of a reference node, according to examples of the present disclosure;

FIG. 3 illustrates a block diagram of a follower node, according to examples of the present disclosure;

FIG. 4 illustrates a method performed by a follower node for the use of propagation delay from topology discovery to update a clock, according to examples of the present disclosure;

FIGS. 5A and 5B illustrate a more detailed method performed by a follower node for the use of propagation delay from topology discovery to update a clock, according to examples of the present disclosure;

FIG. 6 illustrates a method performed by a reference node for the use of propagation delay from topology discovery to update a clock, according to examples of the present disclosure; and

FIG. 7 illustrates a more detailed method performed by a reference node for the use of propagation delay from topology discovery to update a clock, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for the use of propagation delay from topology discovery to update a clock in a 10BASE-T1S mixing segment are provided. The disclosed system and method may use a software algorithm that uses the delay measurement calculated in topology discovery to calculate peer delay between two nodes on a 10BASE-T1S multidrop mixing segment. A 10BASE-T1S multidrop mixing segment may use time synchronization for various use cases. For example, time synchronization may be used for control and sensor use cases (e.g., triggering an actuator at a specific time or timestamping sensor input data) or for audio use cases (e.g., playback using multiple speakers or capturing using multiple microphones). The use of propagation delay from topology discovery to update a clock may be used instead of calculating propagation delay using precision time protocol (PTP) messages.

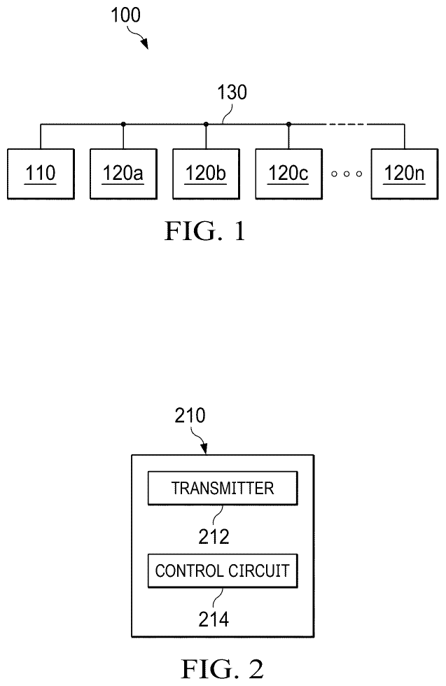

FIG. 1 illustrates a block diagram of a 10BASE-T1S mixing segment, according to examples of the present disclosure. Mixing segment 100 may include reference node 110 and follower nodes 120a through 120n. Reference node 110 and follower nodes 120a through 120n may be communicatively coupled to one another by cable 130.

Reference node 110 may be a node on mixing segment 100 that may initiate data transmission on mixing segment 100. Reference node 110 may also serve as a central point for network communication on mixing segment 100. Reference node 110 may coordinate data transmissions and manage collisions on mixing segment 100. Reference node 110 may receive a clock signal from a clock source. For example, reference node 110 may sync with a higher level clock provided by another device communicatively coupled to reference node 110 (but not part of mixing segment 100). Synchronizing the clock of reference node 110 may allow multiple network segments to be synchronized to a common clock source. For example, in an automotive application, this may allow a turn signal on a rear bumper of a car to toggle at the same time as the audible click sound from a speaker in the dashboard of the car, even though the turn signal and the speaker are on multiple network segments.

Follower nodes 120a through 120n may be nodes on mixing segment 100 that are communicatively coupled to cable 130 but do not actively initiate transmission of timing synchronization messages.

Cable 130 may be used for both transmitting and receiving data, may include a single balanced pair (e.g., an Unshielded Twisted Pair (UTP)). Cable 130 may be a shared cable. Reference node 110 and follower nodes 120a through 120n may communicate over cable 130.

Reference node 110 may instruct a given follower node 120a through 120n to perform a topology discovery operation to determine a propagation delay for data transmissions between reference node 110 and the given follower node 120a through 120n. The propagation delay may be an amount of time for a signal to be received by a node after the signal is sent by a reference node.

Topology discovery is specified by the OPEN Alliance and may be used to determine where (e.g., the distance) a given follower node 120a through 120n is on mixing segment 100. The given follower node 120a through 120n may calculate distance by making a measurement of the propagation delay between the given follower node 120a through 120n and reference node 110. Topology discovery may perform multiple round-trip propagation delay measurements, so at the end of the process, there is a fairly accurate (better than the 10 ns clock) value of the propagation delay. Follower nodes 120a through 120n may then re-use the determined propagation delay to perform clock synchronization that is appropriate for the current network configuration.

To perform the topology discovery operation, reference node 110 may send a plurality of pulses back and forth between reference node 110 and the given follower node 120a through 120n for a set period of time. The given follower node 120a through 120n may count the number of pulses received and determine the propagation delay from this information according to the following formula:

$${t}_{PD} = \frac{1}{2} ( \frac{TIME}{NUM} + Internal Delays )$$

where TIME is the set time during which pulses are sent and NUM is the number of pulses received. Internal Delays may be device dependent and may be characterized by the manufacturer of the given follower node 120a through 120n. Internal Delays as used in the propagation delay calculation may be different than the internal delay measurement used in other aspects of topology discovery. The given follower node 120a through 120n may save the propagation delay after determining the propagation delay.

After the topology discovery operation, reference node 110 may send messages to follower nodes 120a through 120n to allow follower nodes 120a through 120n to update the clock at follower nodes 120a through 120n. Specifically, reference node 110 may send a first message (e.g., a SYNC PTP message) followed by a second message (e.g., a Follow_up PTP message). Reference node 110 may generate the first and second messages for follower nodes 120a through 120n to use to determine a clock error. The first and second messages (e.g., SYNC and Follow_up PTP messages, respectively) may send an exact timestamp of when the messages are transmitted onto cable 130. The message may be received at a given follower node 120a through 120n based on the time it takes to propagate through mixing segment 100. Reference node 110 may send the first and second message continuously while reference node 110 operates. For example, reference node 110 may send the first and second messages approximately eight times per second.

A given follower node 120a through 120n may receive the first and second messages from reference node 110. The given follower node 120a through 120n may record a first timestamp corresponding to the time at which the given follower node 120a through 120n receives the first message. The given follower node 120a through 120n may then calculate the clock error of the clock at the given follower node 120a through 120n using the propagation delay, first timestamp, and second message according to the following formula.

$$Clock Error = ( {t}_{SYNC \_ RX} - {t}_{SYNC \_ TX} ) - {t}_{PD}$$

where t_{SYNC_RX} may be the time the first message (e.g., the SYNC PTP message) is received at the given follower node 120a through 120n, t_{SYNC_TX} may be the time the first message is transmitted by reference node 110, and t_{PD} may be the propagation delay. The given follower node 120a through 120n may determine t_{SYNC_TX} using the second message (e.g., the Follow_up PTP message).

While follower nodes 120a through 120n may calculate the clock error continuously while operating, follower nodes 120a through 120n may calculate the propagation delay once and use the saved propagation delay value for subsequent clock error calculations. However, reference node 110 may instruct follower nodes 120a through 120n to perform the topology discovery operation and update the propagation delay value periodically, such as when mixing segment 100 changes (e.g., when a follower node 120 is added or removed from mixing segment 100) or upon completion of initial installation or system restart.

FIG. 2 illustrates a block diagram of a reference node, according to examples of the present disclosure. Reference node 210 may be similar to reference node 110 shown in FIG. 1.

Transmitter 212 may include receive and transmit circuitry, which may be communicatively coupled to a communication bus, such as cable 130 shown in FIG. 1.

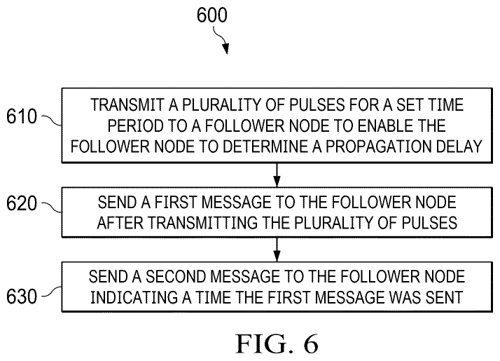

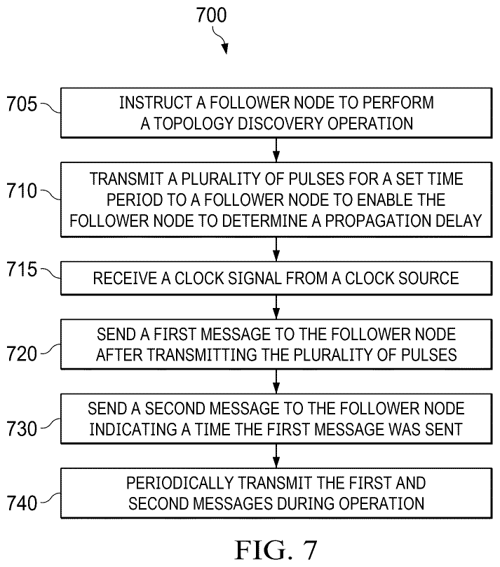

Control circuit 214 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Control circuit 214 control the operations of the components of reference node 210, such as, but not limited to, transmitting a plurality of pulses for a set time period to a follower node and sending a first message and a second message to a follower node. The operations of control circuit 214 are described in further detail with respect to FIGS. 6 and 7.

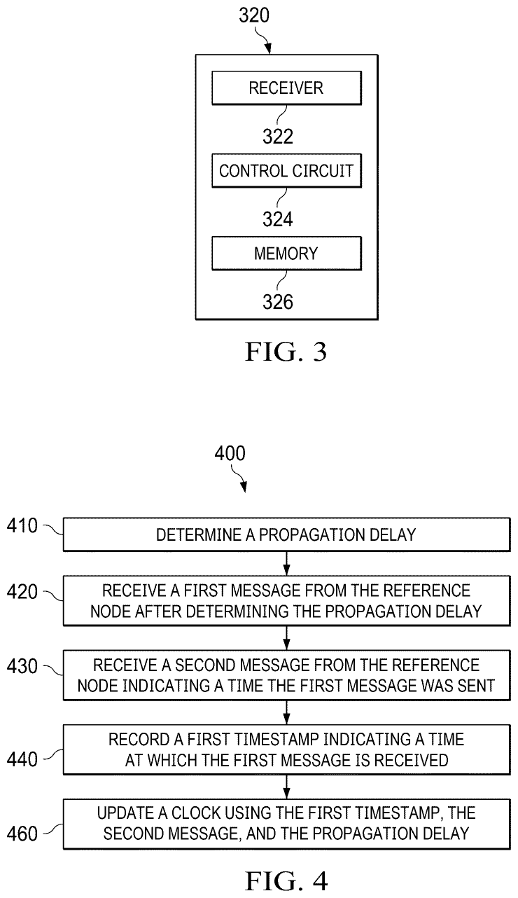

FIG. 3 illustrates a block diagram of a follower node, according to examples of the present disclosure. Follower node 220 may be similar to follower nodes 120a through 120n shown in FIG. 1.

Receiver 322 may include receive and transmit circuitry, which may be communicatively coupled to a communication bus, such as cable 130 shown in FIG. 1.

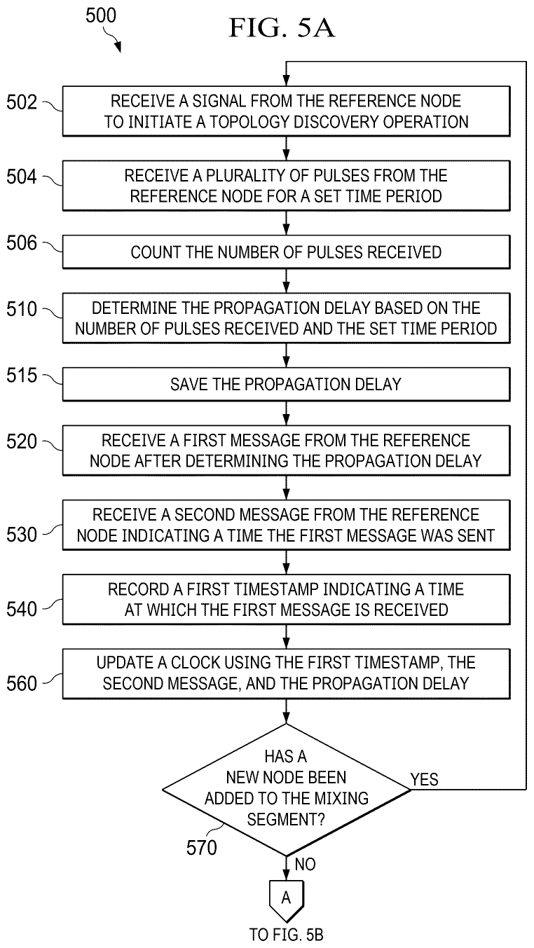

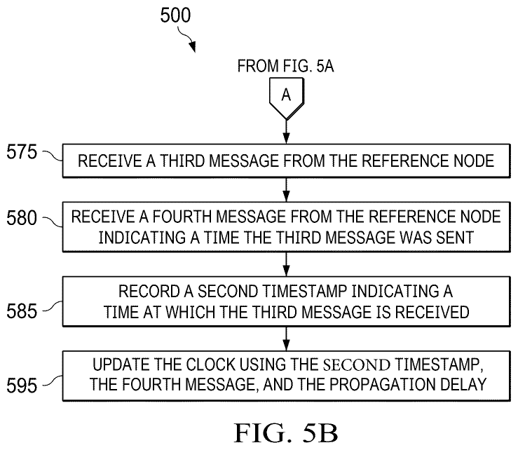

Control circuit 324 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Control circuit 324 control the operations of the components of follower node 220, such as, but not limited to, determining a propagation delay, receiving a first message and a second message from a reference node, recording a first timestamp, and updating a clock using the timestamps and the propagation delay. The operations of control circuit 324 are described in further detail with respect to FIGS. 4 and 5.

Memory 326 may be a non-transitory memory, such as Non-Volatile Memory (NVM), Embedded Non-Volatile Memory (eNVM), Non-Volatile Memory Express (NVMe), volatile memory (e.g., random access memory), or another type of storage not specifically mentioned. Volatile memory may be used in examples where the node is in a configuration where the device containing the nodes is continuously powered and propagation delay is measured after power-on. Memory 326 may store information related to the operation of control circuit 214 such as a propagation delay and a first timestamp.

FIG. 4 illustrates a method performed by a follower node for the use of propagation delay from topology discovery to update a clock, according to examples of the present disclosure. Method 400 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 400, such as control circuit 324 shown in FIG. 3. Although examples have been described above, other variations and examples may be made from this disclosure without departing from the spirit and scope of these disclosed examples.

Method 400 may begin at block 410 where the control circuit may determine a propagation delay. The control circuit may receive a plurality of pulses from a reference node for a set time period. The control circuit may count the number of pulses received and determine the propagation delay from this information according to the following formula:

$${t}_{PD} = \frac{1}{2} ( \frac{TIME}{NUM} + Internal Delays )$$

where TIME is the set time during which pulses are sent and NUM is the number of pulses received.

At block 420, the control circuit may receive a first message from the reference node after determining the propagation delay. The first message may be a SYNC PTP message.

At block 430, the control circuit may receive a second message from the reference node indicating a timestamp indicating when the first message was sent (e.g., tsync_tx). The second message may be a Follow_up PTP message.

At block 440, the control circuit may record a first timestamp indicating a time at which the first message is received.

At block 460, the control circuit may update a clock using the first timestamp, the second message, and the propagation delay. The control circuit may update the clock by calculating a clock error using the propagation delay, first timestamp, and second message according to the following formula.

$$Clock Error = ( {t}_{SYNC \_ RX} - {t}_{SYNC \_ TX} ) - {t}_{PD}$$

where t_{SYNC_RX} may be the time the first message (e.g., the SYNC PTP message) is received at the given follower node 120a through 120n, t_{SYNC_TX} may be the time the first message is transmitted by reference node 110, and t_{PD} may be the propagation delay.

Method 400 may be repeated periodically during operation to update the clock while the system in which control circuit is a part operates.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

FIGS. 5A and 5B illustrate a more detailed method performed by a follower node for the use of propagation delay from topology discovery to update a clock, according to examples of the present disclosure. Method 500 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 500, such as control circuit 324 shown in FIG. 3. Although examples have been described above, other variations and examples may be made from this disclosure without departing from the spirit and scope of these disclosed examples.

Method 500 may begin at block 502 where the control circuit may receive a signal from a reference node to initiate a topology discovery operation. Topology discovery is specified by the OPEN Alliance and may be used to determine where (e.g., the distance) a follower node is on a mixing segment. The follower node may calculate distance by making a measurement of the propagation delay between the follower node and the reference node.

At block 504, the control circuit may receive a plurality of pulses from the reference node for a set time period. At block 506, the control circuit may count the number of pulses received.

At block 510, the control circuit may det determine the propagation delay based on the number of pulses received and the set time period according to the following formula:

$${t}_{PD} = \frac{1}{2} ( \frac{TIME}{NUM} + Internal Delays )$$

where TIME is the set time during which pulses are sent and NUM is the number of pulses received.

At block 515, the control circuit may save the propagation delay. For example, the control circuit may save the propagation delay to a non-transitory memory.

At block 520, the control circuit may receive a first message from the reference node after determining the propagation delay. The first message may be a SYNC PTP message.

At block 530, the control circuit may receive a second message from the reference node indicating a timestamp indicating when the first message was sent (e.g., tsync_tx). The second message may be a Follow_up PTP message.

At block 540, the control circuit may record a first timestamp indicating a time at which the first message is received.

At block 560, the control circuit may update a clock using the first timestamp, the second message, and the propagation delay. The control circuit may update the clock by calculating a clock error using the propagation delay, first timestamp, and second message according to the following formula.

$$Clock Error = ( {t}_{SYNC \_ RX} - {t}_{SYNC \_ TX} ) - {t}_{PD}$$

where t_{SYNC_RX} may be the time the first message (e.g., the SYNC PTP message) is received at the follower node, t_{SYNC_TX} may be the time the first message is transmitted by the reference node, and tpp may be the propagation delay.

At block 570, the control circuit may determine that a request has been received to restart topology discovery. If a request has been received (e.g., new follower node is added to the mixing segment), the topology discovery operation may be repeated and method 500 may return to block 502. If a new follower node has not been added to the mixing segment, method 500 may proceed to block 575.

At block 575, the control circuit may receive a third message from the reference node. The third message may be a second SYNC PTP message.

At block 580, the control circuit may receive a fourth message from the reference node, the fourth message indicating a time the third message was sent. The fourth message may be a second Follow_up PTP message.

At block 585, the control circuit may record a second timestamp indicating a time at which the third message is received.

At block 595, the control circuit may update the clock using the second timestamp, the fourth message, and the propagation delay. The control circuit may update the clock by calculating a clock error using the propagation delay, first timestamp, and second message according to the following formula.

$$Clock Error = ( {t}_{SYNC \_ RX} - {t}_{SYNC \_ TX} ) - {t}_{PD}$$

where t_{SYNC_RX} may be the time the third message (e.g., the SYNC PTP message) is received at the follower node, t_{SYNC_TX} may be the time the third message is transmitted by the reference node, and t_{PD} may be the propagation delay.

Portions of method 500 (e.g., blocks 575 through block 595) may be repeated periodically during operation to update the clock while the system in which control circuit is a part operates.

Although FIGS. 5A and 5B disclose a particular number of operations related to method 500, method 500 may be executed with greater or fewer operations than those depicted in FIGS. 5A and 5B. In addition, although FIGS. 5A and 5B disclose a certain order of operations to be taken with respect to method 500, the operations comprising method 500 may be completed in any suitable order.

FIG. 6 illustrates a method performed by a reference node for the use of propagation delay from topology discovery to update a clock, according to examples of the present disclosure. Method 600 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 600, such as control circuit 214 shown in FIG. 2. Although examples have been described above, other variations and examples may be made from this disclosure without departing from the spirit and scope of these disclosed examples.

Method 600 may begin at block 610 where the control circuit may transmit a plurality of pulses for a set time period to a follower node to enable the follower node to determine a propagation delay. The propagation delay is an amount of time for a signal to be received by the follower node after the signal is sent by a reference node. The control circuit may transmit the plurality of pulses by instructing a transmitter to transmit the plurality of pulses.

At block 620, the control circuit may send a first message to the follower node after transmitting the plurality of pulses. The first message may be a SYNC PTP message.

At block 630, the control circuit may send a second message to the follower node, the second message indicating a time the first message was sent. The second message may be a Follow_up PTP message.

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

FIG. 7 illustrates a more detailed method performed by a reference node for the use of propagation delay from topology discovery to update a clock, according to examples of the present disclosure. Method 700 may be implemented using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to implement method 700, such as control circuit 214 shown in FIG. 2. Although examples have been described above, other variations and examples may be made from this disclosure without departing from the spirit and scope of these disclosed examples.

Method 700 may begin at block 705 where the control circuit may instruct a follower node to perform a topology discovery operation prior to transmitting the plurality of pulses (block 710). Topology discovery is specified by the OPEN Alliance and may be used to determine where (e.g., the distance) a follower node is on a mixing segment. The follower node may calculate distance by making a measurement of the propagation delay between the follower node and the reference node.

At block 710, the control circuit may transmit a plurality of pulses for a set time period to a follower node to enable the follower node to determine a propagation delay. The propagation delay is an amount of time for a signal to be received by the follower node after the signal is sent by a reference node. The control circuit may transmit the plurality of pulses by instructing a transmitter to transmit the plurality of pulses.

At block 715, the control circuit may receive a clock signal from a clock source. The control circuit may receive a clock signal from a clock source. For example, the control circuit may sync with a higher level clock provided by another device communicatively coupled to the control circuit.

At block 720, the control circuit may send a first message to the follower node after transmitting the plurality of pulses. The first message may be a SYNC PTP message.

At block 730, the control circuit may send a second message to the follower node, the second message indicating a time the first message was sent. The second message may be a Follow_up PTP message.

At block 740, the control circuit may periodically send the first and second messages during operation. For example, the control circuit may send the first and second message continuously while the control circuit operates. For example, the control circuit may send the first and second messages approximately eight times per second.

Although FIG. 7 discloses a particular number of operations related to method 700, method 700 may be executed with greater or fewer operations than those depicted in FIG. 7. In addition, although FIG. 7 discloses a certain order of operations to be taken with respect to method 700, the operations comprising method 700 may be completed in any suitable order.

Although examples have been described above, other variations and examples may be made from this disclosure without departing from the spirit and scope of these disclosed examples.

1. A method, comprising:
determining a propagation delay, the propagation delay is an amount of time for a signal to be received by a node after the signal is sent by a reference node;
receiving, at the node, a first message from the reference node after determining the propagation delay;
receiving, at the node, a second message from the reference node, the second message indicating a time the first message was sent;
recording, at the node, a first timestamp indicating a time at which the first message is received; and
updating a clock of the node using the first timestamp, the second message, and the propagation delay.

2. The method of claim 1, wherein determining the propagation delay includes:
receiving, at the node, a plurality of pulses from the reference node for a set time period;
counting a number of pulses received; and
determining the propagation delay based on the number of pulses received and the set time period.

3. The method of claim 1, comprising:
receiving, at the node, a signal from the reference node to initiate a topology discovery operation;
wherein:
the reference node is part of a mixing segment including the reference node and a follower node;
receiving the signal from the reference node occurs after a new follower node is added to the mixing segment; and
determining the propagation delay is performed during the topology discovery operation.

4. The method of claim 1, comprising:
receiving, at the node, a third message from the reference node;
receiving, at the node, a fourth message from the reference node, the fourth message indicating a time the third message was sent;
recording, at the node, a second timestamp indicating a time at which the third message is received; and
updating the clock using the second timestamp, the fourth message, and the propagation delay.

5. The method of claim 1, comprising saving the propagation delay.

6. An apparatus, comprising:
a receiver; and
a control circuit to:
determine a propagation delay, the propagation delay is an amount of time for a signal to be received by the receiver after the signal is sent by a reference node;
receive, using the receiver, a first message from the reference node after determining the propagation delay;
receive, using the receiver, a second message from the reference node, the second message indicating a time the first message was sent;
record a first timestamp indicating a time at which the first message is received; and
update a clock using the first timestamp, the second message, and the propagation delay.

7. The apparatus of claim 6, wherein the control circuit is to, in order to determine the propagation delay:
receive, using the receiver, a plurality of pulses from the reference node for a set time period;
count a number of pulses received; and
determine the propagation delay based on the number of pulses received and the set time period.

8. The apparatus of claim 6, wherein the control circuit is to:
receive, using the receiver, a signal from the reference node to initiate a topology discovery operation; and
determine the propagation delay during the topology discovery operation;
wherein:
the reference node is part of a mixing segment including the reference node and a follower node; and
receiving the signal from the reference node occurs after a new follower node is added to the mixing segment.

9. The apparatus of claim 6, wherein the control circuit is to:
receive, using the receiver, a third message from the reference node;
receive, using the receiver, a fourth message from the reference node, the fourth message indicating a time the third message was sent;
record a second timestamp indicating a time at which the third message is received; and
update the clock using the second timestamp, the fourth message, and the propagation delay.

10. The apparatus of claim 6, comprising:
a non-volatile memory;
wherein the control circuit is to save the propagation delay to the non-volatile memory.

11. A method, comprising:
transmitting a plurality of pulses for a set time period to a follower node to enable the follower node to determine a propagation delay, the propagation delay is an amount of time for a signal to be received by the follower node after the signal is sent by a reference node;
sending a first message to the follower node after transmitting the plurality of pulses; and
sending a second message to the follower node, the second message indicating a time the first message was sent.

12. The method of claim 11, comprising instructing a follower node to perform a topology discovery operation prior to transmitting the plurality of pulses.

13. The method of claim 11, wherein the first and second messages are precision time protocol messages.

14. The method of claim 11, comprising receiving a clock signal from a clock source.

15. The method of claim 11, wherein the first and second messages are periodically transmitted during operation.

16. An apparatus, comprising:
a transmitter; and
a control circuit to:
instruct the transmitter to transmit a plurality of pulses for a set time period to a follower node to enable the follower node to determine a propagation delay, the propagation delay is an amount of time for a signal to be received by the follower node after the signal is sent by a reference node;
send a first message to the follower node after transmitting the plurality of pulses; and
send a second message to the follower node, the second message indicating a time the first message was sent.

17. The apparatus of claim 16, wherein the control circuit is to instruct a follower node to perform a topology discovery operation prior to transmitting the plurality of pulses.

18. The apparatus of claim 16, wherein the first and second messages are precision time protocol messages.

19. The apparatus of claim 16, wherein the control circuit is to receive a clock signal from a clock source.

20. The apparatus of claim 16, wherein the control circuit is to periodically send the first and second messages during operation.
